(19) United States
(12) Patent Application Publication
(10) Pub. No.: US 2007/0273681 A1
(43) Pub. Date: Nov. 29, 2007

(54) Method and apparatus to power light emitting diode arrays

(76) Inventor: Robert J. Mayell, San Francisco, CA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/440,606

(22) Filed: May 24, 2006

(51) Int. Cl. G09G 5/00

(52) U.S. Cl. 345/211

(57) ABSTRACT

A light emitting diode array powering method and apparatus is disclosed. An apparatus according to aspects of the present invention includes a power supply circuit having input terminals and output terminals. The input terminals of the power supply circuit are to be coupled to receive a supply voltage. A plurality of loads is to be coupled between the output terminals. The power supply circuit is coupled to provide an output voltage between the output terminals to be applied across each one of the plurality of loads coupled between the output terminals. A feedback selector circuit is coupled between the power supply circuit and the plurality of loads. The feedback selector circuit is coupled to receive a feedback signal from each one of the plurality of loads. The power supply circuit is coupled to be responsive to only one of the feedback signals at any one time.

### BACKGROUND OF THE INVENTION

1. Field of the Invention

The present invention relates generally to power supplies, and more specifically, the present invention relates to powering electronic circuits.

2. Background Information

Light emitting diode (LED) arrays are used for a variety of purposes. For example, such arrays are often applied in backlighting for liquid crystal displays (LCDs). Generation of white light for such displays is usually accomplished by mixing the light from red, green, and blue LEDs. For larger lighting applications, power is supplied to a large array of red, green, and blue LEDs, often from a single power supply.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1A is a block diagram illustrating generally an example schematic of a circuit providing power to an array of LEDs in accordance with the teachings of the present invention.

FIG. 1B is a block diagram illustrating generally another example schematic of a circuit providing power to an array of LEDs in accordance with the teachings of the present invention.

FIG. 2 is a schematic diagram illustrating generally an example of a load including a current source and a voltage limited component in accordance with the teachings of the present invention.

FIG. 3 is a schematic diagram illustrating generally another example of a load including a current source and a voltage limited component in accordance with the teachings of the present invention.

FIG. 4 is a block diagram illustrating generally another example schematic of a circuit providing power to an array of LEDs in accordance with the teachings of the present invention.

FIG. 5 is a block diagram illustrating generally an example schematic of a circuit providing power to a string of LEDs in accordance with the teachings of the present invention.

### DETAILED DESCRIPTION

Examples of apparatuses and methods for powering LEDs are disclosed. In the following description, numerous specific details are set forth in order to provide a thorough understanding of the present invention. It will be apparent, however, to one having ordinary skill in the art that the specific detail need not be employed to practice the present invention. Well-known methods related to the implementation have not been described in detail in order to avoid obscuring the present invention.

Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures or characteristics may be combined for example into any suitable combinations and/or sub-combinations in one or more embodiments.

As will be discussed, the spectrum of light from an LED is strongly influenced by the current in the LED. When the LED is illuminated, it operates at a specified current to provide the desired optical spectrum. The average output from the LED is controlled by pulse width modulation (PWM) of the current in the LED. As such, the LED conducts either the specified current or zero current at a duty ratio according to the PWM to achieve the desired output. Blending the spectra from red, green, and blue LEDs in the proper portions creates the desired white color and intensity of the backlight.

A complication in providing power from a single power supply to multiple LEDs is that each LED may typically operate at a different voltage that changes with operating temperature. These multiple LEDs may be of different color, such as for example red, green, and blue LEDs. Also, the desired spectrum from each color LED is obtained typically at a different operating current. The power supply should provide a voltage just high enough to illuminate all the LEDs at their rated current, since a higher voltage will waste power. As will be discussed, various examples in accordance with the teachings of the present invention automatically adjust the voltage of a single power supply to provide sufficient voltage for an array of LEDs operating at different voltages and different currents at optimal efficiency.

In one example, a single power supply that includes a feedback selector is used to obtain a single feedback signal from one of a plurality of current sources. In one example, each current source is included in a load that contains a voltage-limited component in accordance with the teachings of the present invention. In one example, the voltage-limited component comprises one or more LEDs. The feedback selector chooses the feedback signal to maintain the minimum voltage from the power supply to operate the LEDs in accordance with the teachings of the present invention.

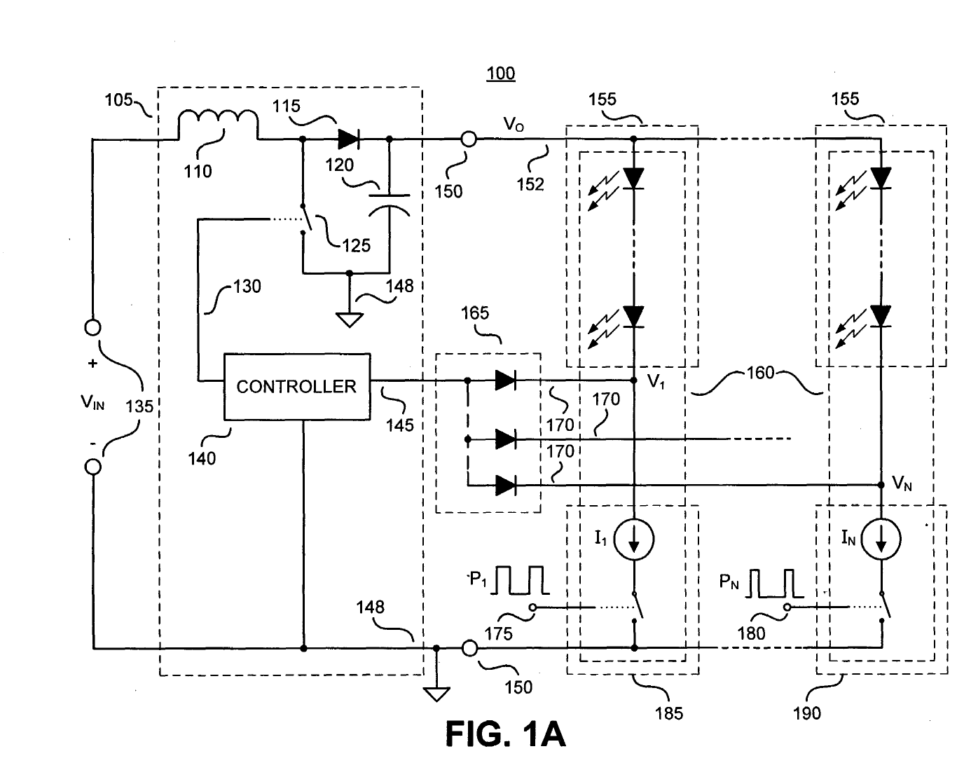

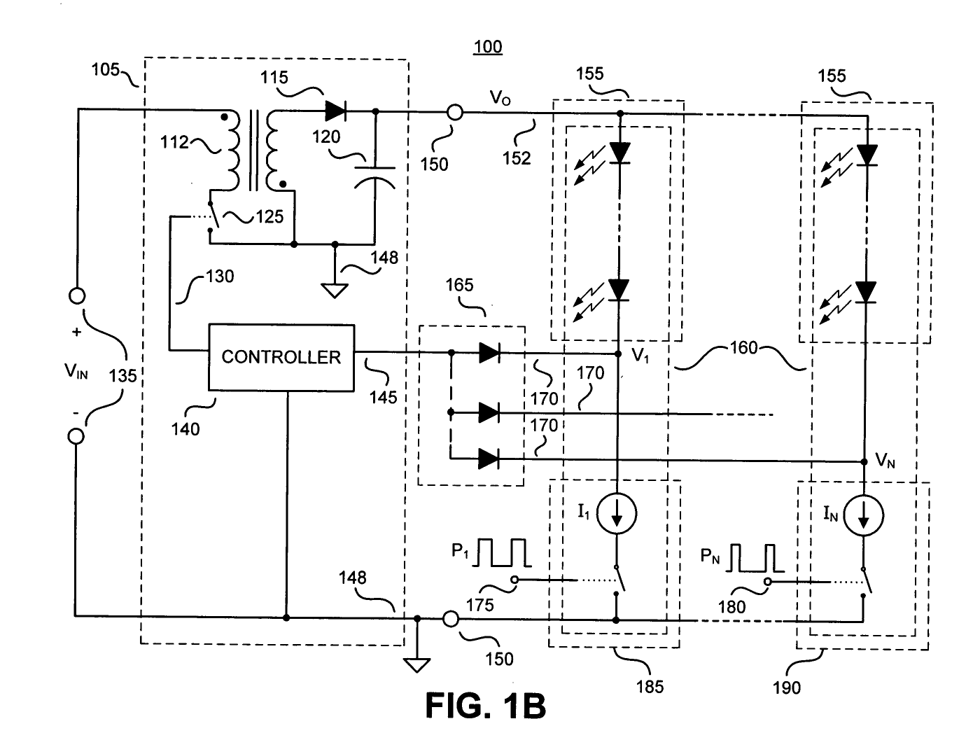

To illustrate, FIG. 1A shows generally one example of a circuit providing power to an array of LEDs in accordance with the teachings of the present invention. As shown, a backlighting circuit 100 includes a switching power supply circuit 105 coupled to one or more loads 160 and a feedback selector 165. Switching power supply circuit 105 receives an input voltage V_{IN} at input terminals 135 and produces an output voltage V_{O} at terminals 150. In the illustrated example, all voltages are measured with respect to a common input and output return 148.

In the example illustrated in FIG. 1A, switching power supply circuit 105 is a boost converter including an inductor 110 employed as an energy transfer element, an output rectifier 115, an output capacitor 120, and a switch 125. Although power supply circuit 105 is illustrated in FIG. 1A with a boost converter topology for explanation purposes, it is appreciated that other power supply topologies may implemented in accordance with the teachings of the present invention. For instance, FIG. 1B shows generally a switching power supply circuit 105 having a flyback converter topology in accordance with the teachings of the present invention. In the flyback converter topology illustrated generally in FIG. 1B, a transformer having multiple windings is used as an energy transfer element instead of the inductor used in FIG. 1A. All other aspects of the circuit illustrated generally in FIG. 1B are similar to the circuit illustrated in FIG. 1A. It is noted that still more example power supply topologies other than the example boost converter and flyback examples shown in FIG. 1A and FIG. 1B may be employed in the alternative, including for example a buck converter, or another suitable power supply topology in accordance with the teachings or the present invention.

Returning the specific example illustrated in FIG. 1A, during operation, a switch 125 is switched on and off by a controller 140, which receives a feedback signal 145 from the feedback selector 165. In the illustrated example, feedback signal 145 is one of one or more N feedback signals 170 that are N voltages V₁ through V_{N} corresponding to voltages across current sources I₁ 185 through I_{N} 190 or the one or more loads 160 in accordance with the teachings of the present invention.

As shown in FIG. 1A, each of the one or more loads 160 includes a voltage-limited component 155, which in one example could be one or more LEDs that have different voltages. In general, rectifier diodes, Zener diodes, avalanche diodes, LEDs, batteries, or the like, are examples of voltage-limited devices in accordance with the teachings of the present invention. In operation, the voltage across the voltage-limited component 155 does not increase substantially when the current through the component is greater than a conduction current. In the illustrated example, all of the one or more loads 160 receive the same voltage output voltage V_{O} 152 from the output terminals 150 of the power supply circuit 105.

As shown in the depicted example, voltage V₁ is a switching voltage across current source 185 and voltage V_{N} is a switching voltage across current source 190 of the one or more loads 160. Current source 185 conducts either current I₁ or zero current in response to the pulse width modulated signal P₁ at terminal 175. Current source 190 conducts either current I_{N} or zero current in response to pulse width modulated signal P_{N} at terminal 180. In one example, the pulse width modulated signals P₁ . . . P_{N} are externally generated to control the current through each of the one or more loads 160. Therefore, each of the one or more loads 160 comprises a switch coupled to switch load current flowing in the respective load in response to the pulse width modulated signal in accordance with the teachings of the present invention. In addition, since the pulse width modulated signals P₁ . . . P_{N} are generated externally, each of the current sources in the one or more loads 160 are switched independently of the switching power supply 105 in accordance with the teachings of the present invention.

Feedback selector 165 in the example of FIG. 1A causes the feedback voltage 145 to be the lowest of the continuum of switching voltages V₁ through V_{N} of all of the one more loads 160. In operation, controller 140 then causes switching regulator 105 to produce an output voltage V₀ 152 that maintains the feedback voltage 145 at a regulated voltage. In the illustrated example, feedback selector 165 is coupled to combine the continuum of feedback signals 170 received from all of the one or more loads 160 through a one or more respective diodes coupled to select one single feedback voltage 145 received at a single feedback terminal of the power supply circuit 105 in accordance with the teachings of the present invention. Therefore, in an example with more than one load 160, the power supply circuit 105 is coupled to be responsive to only one of the feedback signals 170 at any one time in accordance with the teachings of the present invention. In an example with only one load 160, the power supply 105 is responsive to only the lowest of the continuum of switching voltages received from feedback signal 170 in accordance with the teachings of the present invention.

In the example illustrated in FIG. 1A, one or more loads 160 and one or more respective diodes in selector circuit 165 are included. In another example, a single load 160 having a single switched current source 190 and single voltage-limited component 155 may be included in accordance with the teachings of the present invention. For instance, in one such example, only a single load 160 of multiple LEDs is powered by power supply 105 rather than a plurality of loads 160 or strings of LEDs. Thus, a single load 160 with a single feedback signal 170 from the switched current source 190 is included in accordance with the teachings of the present invention. Selector circuit 165 receives the single feedback signal 170 and selects the lowest of the continuum of switching voltages received from the single feedback signal 170 for feedback voltage 145 in accordance with the teachings of the present invention.

In one single load 160 example, the single load 160 has a switched current source 190 and a voltage-limited component 155 and is used with feedback selector circuit 165 having a single diode coupled between a single feedback terminal of the power supply circuit 105 and single load 160. In operation, the feedback selector circuit 165 receives the single feedback signal 170 from the switched current source 190, selects the lowest value of the single feedback signal 170 voltage from the continuum of switching voltages on the switched current source 190 as it is switched, and provides this lowest value of the single feedback signal 170 as the single feedback voltage 145 to which the power supply 105 is responsive in accordance with the teachings of the present invention.

Current sources generally require a minimum voltage to operate. Referring back to the specific circuit example in FIG. 1A with one or more loads 160, the current sources 185 through 190 of the loads 160 receive the difference between the output voltage V_{O} 152 and the voltage across the voltage-limited components 155. In one example, the voltage-limited components 155 typically have a different voltage in each of the one or more loads 160. Each of the one or more loads 160 is coupled to conduct a load current specific to that load. The regulated feedback voltage 145 is chosen by a designer to be the minimum voltage to help ensure proper operation of the current sources 185 through 190 in the loads 160. Thus, the circuit example illustrated in FIG. 1A operates with the highest efficiency since the lowest of the voltages V₁ through V_{N} is selected by feedback selector 165 for feedback voltage 145, which therefore should result in the lowest output voltage V_{O} 152 and thereby in the lowest necessary dissipation of power in the current sources in accordance with the teachings of the present invention.

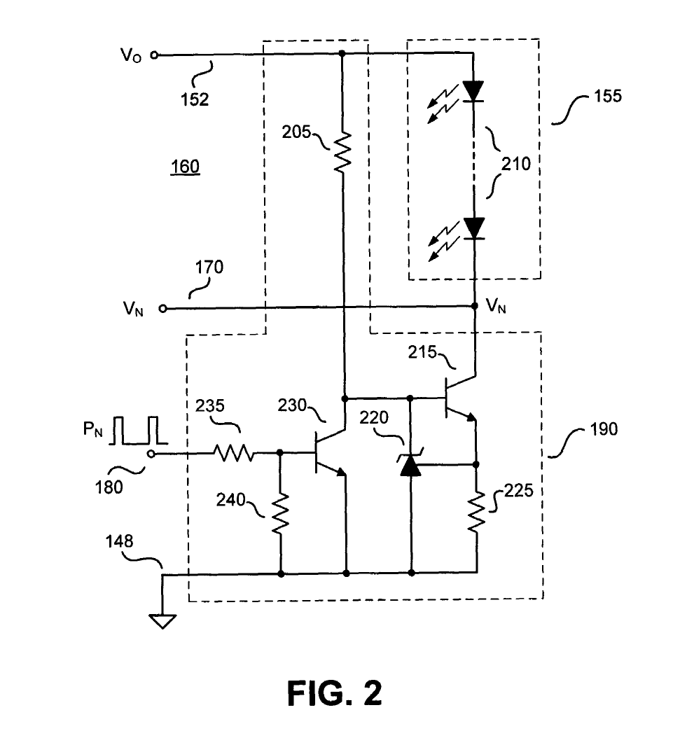

FIG. 2 shows generally one example of a load 160 that includes a current source 190 and a voltage-limited component 155 in accordance with the teachings of the present invention. The illustrated voltage-limited component 155 includes a string of LEDs 210 coupled together. In FIG. 2, a transistor 215 is coupled to a shunt regulator 220 and a current sensing resistor 225 in the configuration of a constant current sink to regulate the current in the string of LEDs 210. In one example, the shunt regulator 220 is an LMV431 shunt regulator. In operation, resistor 205 provides the current necessary for the operation of transistor 215 and the shunt regulator 220. Transistor 230 with resistors 235 and 240 form a switch responsive to a pulse width modulated signal P_{N} at a terminal 180. When pulse width modulated signal P_{N} is at a high level, transistor 230 switches on to remove base current from transistor 215, and the current in the string of LEDs 210 is reduced to zero in accordance with the teachings of the present invention.

In one example, the desired current is established in the string of LEDs 210 when approximately 1.2 volts are across the current sense resistor 225. In the illustrated example, transistor 215 functions as a current source when there is more than approximately 100 millivolts between the collector and emitter of transistor 215. Therefore, the example switching regulator 105 of the circuit of FIG. 1A would be designed to regulate the feedback voltage V_{N} to a minimum value that is approximately 1.35 volts in the illustrated example.

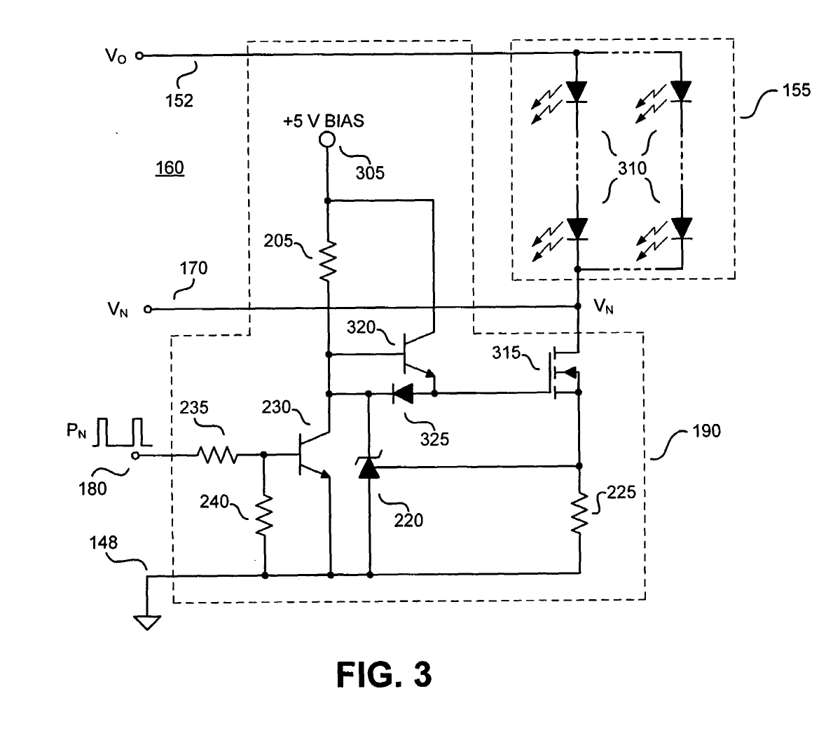

FIG. 3 shows generally another example of a load 160 that includes a current source 190 and a voltage-limited component 155 in accordance with the teachings of the present invention. The voltage-limited component 155 includes parallel strings of LEDs 310 coupled together as shown in the illustrated example. In one example, when the number of LEDs in each parallel string is large, current from the current source 190 will divide among the strings nearly equally. Current source 190 in the example shown in FIG. 3 includes a metal oxide semiconductor field effect transistor (MOSFET) 315 as an alternative to the bipolar transistor 215 example illustrated in FIG. 2. As shown in the example of FIG. 3, MOSFET 315 is driven by NPN bipolar transistor 320 from a bias voltage 305. A diode 325 is coupled to the gate of MOSFET 315, which allows rapid discharge of the gate capacitance of MOSFET 315 when NPN transistor 230 switches on as shown in the illustrated example.

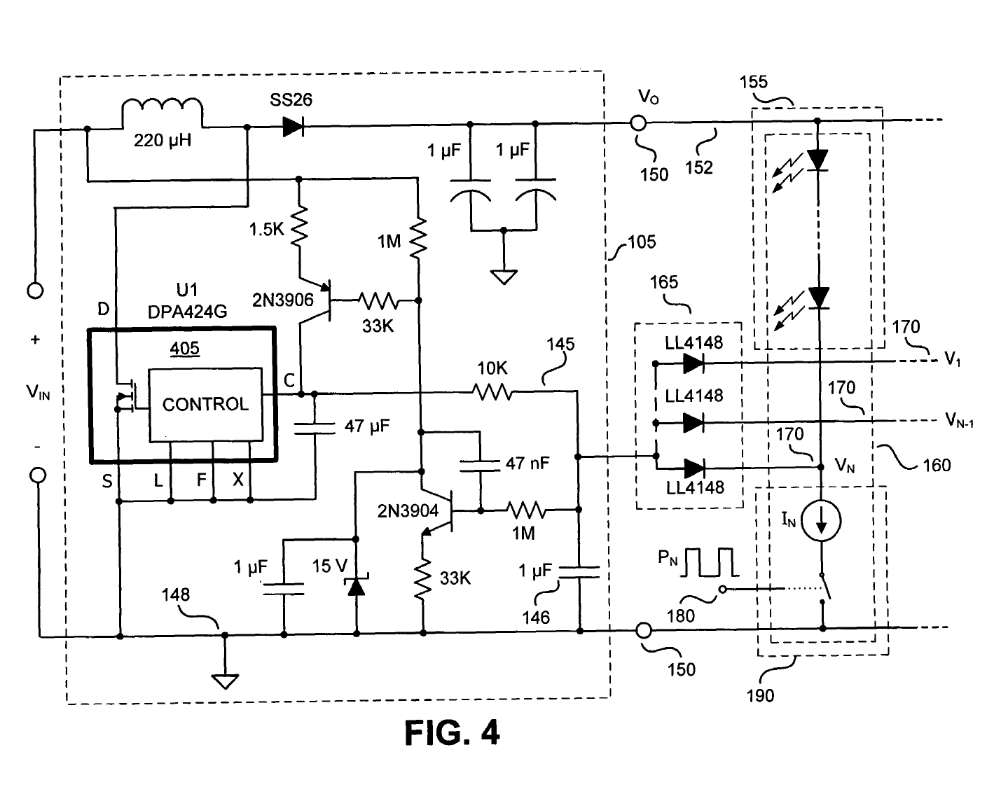

FIG. 4 is a block diagram illustrating generally another example schematic of a circuit providing power to an array of LEDs in accordance with the teachings of the present invention. In the illustrated example, FIG. 4 shows details of a power supply with a load 160 that could be included in the circuit examples of FIG. 2 or FIG. 3. In the specific example shown in FIG. 4, integrated circuit U1 405 is a DPA424G device from Power Integrations, Inc., San Jose, Calif. The integrated circuit U1 405 includes a power MOSFET and a controller that performs the functions of the switch 125 and the controller 140 in FIG. 1A in accordance with the teachings of the present invention. In the specific example shown in FIG. 4, selector circuit 165 includes LL4148 fast switching diodes coupled to receive each one of the feedback signals 170 from each respective one of the one or more loads 160. As shown, the plurality of diodes in selector circuit 165 are coupled together to provide a single feedback signal 145, to which integrated circuit U1 405 is responsive to regulate the output voltage V₀ 152.

In the circuit illustrated in FIG. 4, capacitor 146 is coupled to provide feedback voltage 145 and is effectively a valley detector. In the illustrated example, capacitor 146 holds the lowest voltage that comes from the feedback selector 165, whether it is the lowest voltage from one load or from many loads. In various examples, it is noted that capacitor 146 may be a discrete capacitor or may be integrated in an integrated circuit in accordance with the teachings of the present invention.

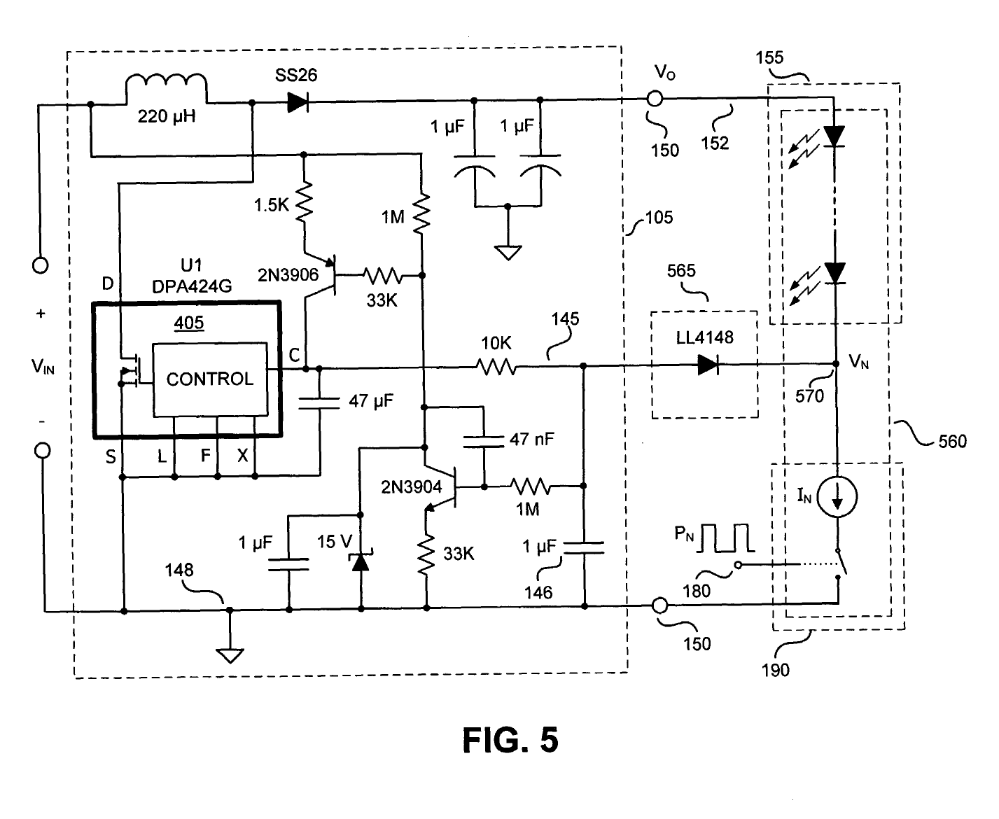

FIG. 5 is a block diagram illustrating generally an example schematic of a circuit providing power to a string of LEDs in accordance with the teachings of the present invention. The example circuit illustrated in FIG. 5 is similar to the example circuit illustrated in FIG. 4 except that one load 560 is illustrated in FIG. 5 with one corresponding LL4148 diode in selector circuit 565 to select the lowest of the continuum of voltages V_{N} 570 in accordance with the teachings of the present invention. In contrast, the specific example illustrated in FIG. 4 illustrates a plurality of loads 160 with a corresponding plurality of LL4148 diodes in selector circuit 165. Operation of the circuit illustrated in FIG. 5 is similar to the circuit illustrated in FIG. 4 in accordance with the teachings of the present invention.

In the foregoing detailed description, the method and apparatus of the present invention have been described with reference to a specific exemplary embodiment thereof. It will, however, be evident that various modifications and changes may be made thereto without departing from the broader spirit and scope of the present invention. The present specification and figures are accordingly to be regarded as illustrative rather than restrictive.

What is claimed is:

1. A circuit, comprising:
a power supply circuit having input terminals and output terminals, wherein the input terminals are to be coupled to receive a supply voltage, wherein a plurality of loads are to be coupled between the output terminals, wherein the power supply circuit is coupled to provide an output voltage between the output terminals to be applied across each one of the plurality of loads coupled between the output terminals; and
a feedback selector circuit coupled between the power supply circuit and the plurality of loads, wherein the feedback selector circuit is coupled to receive a feedback signal from each one of the plurality of loads, wherein the power supply circuit is coupled to be responsive to only one of the feedback signals at any one time.

2. The circuit of claim 1 wherein each one of the plurality of loads comprises voltage-limited components.

3. The circuit of claim 2 wherein the voltage limited components comprise light emitting diodes.

4. The circuit of claim 1 wherein the feedback selector circuit is coupled to combine the feedback signals received from the plurality of loads through a plurality of diodes coupled to a single feedback terminal of the power supply circuit.

5. The circuit of claim 1 wherein the power supply circuit is a boost converter.

6. The circuit of claim 1 wherein each of the plurality of loads is coupled to conduct a load current specific to that load.

7. The circuit of claim 6 wherein each of the plurality of loads comprises a switch coupled to switch load current flowing in the respective load.

8. The circuit of claim 7 wherein the switch is coupled to be switched independently of the power supply circuit.

9. The circuit of claim 7 wherein each of the plurality of loads comprises a current source coupled to the switch.

10. The circuit of claim 1 wherein the power supply circuit is a flyback converter.

11. The circuit of claim 10 wherein each of the plurality of loads comprises a switch coupled to switch load current flowing in the respective load.

12. The circuit of claim 11 wherein each of the plurality of loads comprises a current source coupled to the switch.

13. The circuit of claim 11 wherein the switch is coupled to be switched independently of the power supply circuit.

14. A circuit, comprising:
a power supply circuit having input terminals and output terminals, wherein the input terminals are to be coupled to receive a supply voltage, wherein a load is to be coupled between the output terminals, wherein the power supply circuit is coupled to provide an output voltage between the output terminals to be applied across the load coupled between the output terminals; and
a feedback selector circuit coupled between the power supply circuit and the load, wherein the feedback selector circuit is coupled to receive feedback signal from the load and select a lowest value of the feedback signal from a continuum of values to provide a single feedback voltage to which the power supply circuit is responsive.

15. The circuit of claim 14 wherein the load comprises voltage-limited components.

16. The circuit of claim 15 wherein the voltage limited components comprise light emitting diodes.

17. The circuit of claim 14 wherein the feedback selector circuit is coupled to receive the continuum of values of feedback signal from the load through a diode coupled to a single feedback terminal of the power supply circuit.

18. The circuit of claim 14 wherein the power supply circuit is a boost converter.

19. The circuit of claim 14 wherein the load is coupled to conduct a load current specific to that load.

20. The circuit of claim 19 wherein the load comprises a switch coupled to switch load current flowing in the respective load.

21. The circuit of claim 20 wherein the switch is coupled to be switched independently from the power supply circuit.

22. The circuit of claim 20 wherein the load comprises a current source coupled to the switch.

23. The circuit of claim 14 wherein the power supply circuit is a flyback converter.

24. The circuit of claim 23 wherein the load comprises a switch coupled to switch load current flowing in the respective load.

25. The circuit of claim 24 wherein the load comprises a current source coupled to the switch.

26. The circuit of claim 24 wherein the switch is coupled to be switched independently from the power supply circuit.
